(19) United States
(12) Patent Application Publication
(10) Pub. No.: US 2009/0223083 A1
(43) Pub. Date: Sep. 10, 2009

(54) BEARING INCLUDING SENSOR AND DRYING DRUM INCLUDING SAME

(75) Inventor: Timothy J. LeCrone, Rockford, IL (US)

Correspondence Address: REINHART BOERNER VAN DEUREN P.C., 2215 PERRYGREEN WAY, ROCKFORD, IL, 61107, US

(73) Assignee: Pacific Bearing Company, Rockford, IL (US)

(21) Appl. No.: 12/398,210

(22) Filed: Mar. 5, 2009

Related U.S. Application Data
(60) Provisional application No. 61/034,526, filed on Mar. 7, 2008.

(51) Int. Cl. F26B 25/00; F16C 41/00; G01N 3/56; D06F 58/04

(52) U.S. Cl. 34/524; 384/129; 73/7; 34/108

(57) ABSTRACT

A bearing including a wearable section including a wear sensor is provided. The bushing includes a wear sensor that provides feedback to a user relating to the amount of useable life of the bearing that has been used. The sensor may be in the form of a wire imbedded in the wearable section of the bearing such that as the wearable section wears over time, the wire may be worn through breaking a circuit including the wire. An indicator module can sense the breakage of the wire and determine the amount of useable life of the bearing that has been used. In one implementation, the bearing is used in a drying drum. In one form of the invention, a method of monitoring wear of the bearing is provided that includes monitoring changes in electrical properties of a sensor mounted in the bearing.

### CROSS-REFERENCE TO RELATED PATENT APPLICATIONS

This patent application claims the benefit of U.S. Provisional Patent Application No. 61/034,526, filed Mar. 7, 2008, the entire teachings and disclosure of which are incorporated herein by reference thereto.

### FIELD OF THE INVENTION

This invention generally relates to bearings and more particularly to devices and methods for indicating and measuring the remaining useful life of bearings.

### BACKGROUND OF THE INVENTION

In some implementations, bearings are used to support devices that rotate such as mounting or drive shafts. Over time, the bearing will wear due to the interaction between the bearing and the rotating shaft. In some implementations, bearing failure can result in additional, substantial at times catastrophic damage to the shaft or device that is supported by the bearing.

In the past, devices measured characteristics of the system relating to failure of the bearing to determine when the bearing required maintenance. Such characteristics include temperature, vibration, lubrication pressure, debris in lubrication, lubrication restrictions, etc. However, by measuring failure characteristics, the bearing has failed or almost at failure and therefore potential damage can occur to the supported shaft or devices connected to the shaft.

Further, in many systems, once failure occurs, the system needs to be shut down, which if damage occurs to other components can result in increased down time. As such, waiting for failure to determine when to repair the bearing can be costly and result in un-necessarily long down time. Further, if failure occurs when the system is full of materials, in some implementations, the stoppage of the line can result in spoilage of the materials in the system such that all materials that are not finished must be discarded.

These previous devices or methods for analyzing bearing failure and life thus do not provide much predictability of remaining bearing life.

In one particular implementation, namely in supporting a journal of a paper drying drum, the bearing may be subjected to very high pressure and velocity due to the large loading.

There exists, therefore, a need in the art for a device or bearing that provides the user feedback as to remaining useful life of the bearing and to indicate when a bearing needs to be replaced prior to failure of the bearing.

### BRIEF SUMMARY OF THE INVENTION

The present invention has several aspects that may be claimed and stand as patentable independently and individually or in combination with other aspects, including but not limited to the following.

In one embodiment, a bearing for supporting a rotating shaft including a sensor for measuring the amount of wear of the bearing is provided. The bearing includes a wearable portion and at least one sensor. The wearable portion decreases in thickness as the wearable portion progressively wears due to aggregate use. The wearable portion includes a shaft support surface. The at least one sensor is positioned within the wearable portion at a predetermined position along the thickness of the wearable portion and offset from the shaft support surface.

In one implementation of the bearing, the bearing is a bushing.

In another implementation, a plurality of sensors are provided in the form of a plurality of wires embedded in the wearable portion. In other implementations, the sensor is a continuous sheet of electrically conductive material that changes electrical properties as the cross-section of the sheet decreases.

In another embodiment, a rotatable drying drum for drying moist articles comprising a drum, a journal, a bearing and a sensor is provided. The drum can be used to house moist articles that are dried. The journal is operably coupled to the drum. The bearing supports the journal for rotation on a wearable portion. The wearable portion is configured to wear a predetermined amount before needing replacement. The sensor is disposed within the wearable portion a predetermined distance from a bearing surface of the wearable portion. Interaction of the journal and the sensor after a predetermined amount of wear in the wearable portion allows determination that said amount of wear of the wearable portion has occurred.

In a further implementation of the invention, a method of monitoring wear of a wearable portion of a bearing is provided. The method includes sensing an electrical property of a first sensor mounted in the wearable portion of the bearing that decreases in thickness as the wearable portion progressively wears, the wearable portion including a support surface, the first sensor being mounted a first predetermined distance from the support surface. The method further includes sensing a change in the electrical property of the first sensor. Additionally, the method includes determining a first degree of wear of the wearable portion upon the sensed change in the electrical property of the first sensor.

In a preferred implementation, the step of sensing a change in the electrical property of the first sensor includes sensing that an electrical circuit established by the first sensor is broken.

The method may also include the additional steps of 1) sensing an electrical property of a second sensor mounted in the wearable portion of the bearing a second predetermined distance from the support surface, the second predetermined distance being further from the support surface than the first predetermined distance; 2) sensing a change in the electrical property of the second sensor; and 3) determining a second degree of wear of the wearable portion upon the sensed change in the electrical property of the second sensor. In this form of the method, the first degree of wear identifies an acceptable amount of wear and the second degree of wear identifies a replacement required degree of wear such that the bearing, or at least the wearable portion, needs to be replaced. Further yet, the second degree of wear may be established at a non-complete failure predetermined distance from the support surface such that the bearing has not yet failed but that it will fail in a short period of time, thereby eliminating damage prior to indicating a need to replace the bearing.

Other embodiments of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top perspective illustration of a saddle bushing according to the teachings of the present invention;

FIG. 2 is a top plan view of the saddle bushing of FIG. 1;

FIG. 3 is a schematic implementation of the saddle bushing of FIG. 1 used in a drying drum;

FIG. 4 is a simplified end view of the saddle bushing of FIG. 1 coupled to an indicator module;

FIG. 5 is a further simplified end view of the saddle bushing of FIG. 4 illustrating the inclusion of numerous sensor wires;

FIG. 6 is simplified cross-section of a bushing liner illustrating sensor wires imbedded in the bushing liner;

FIG. 7 is a simplified cross-section of another bushing liner illustrating sensor wires mounted in channels formed in the bushing liner;

FIG. 8 illustrates another embodiment of a bushing liner using normally off technology; and

FIG. 9 is a further simplified cross-section of another bushing liner illustrating a sensor using a continuous sheet extending along the thickness of the bushing liner.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

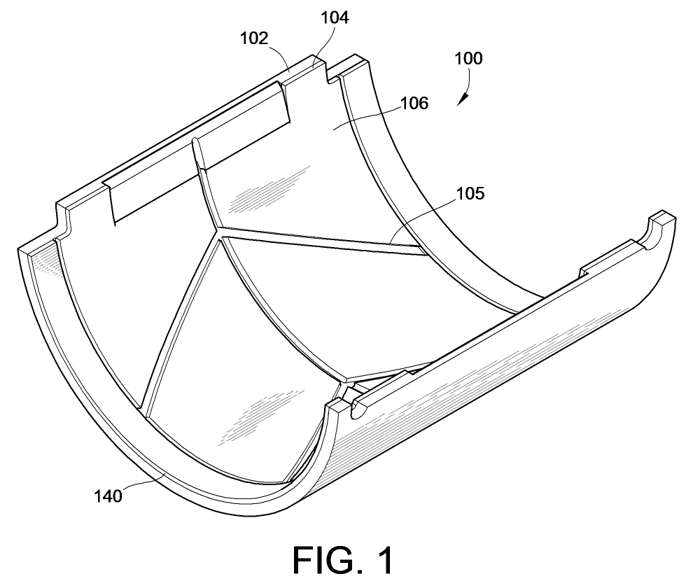

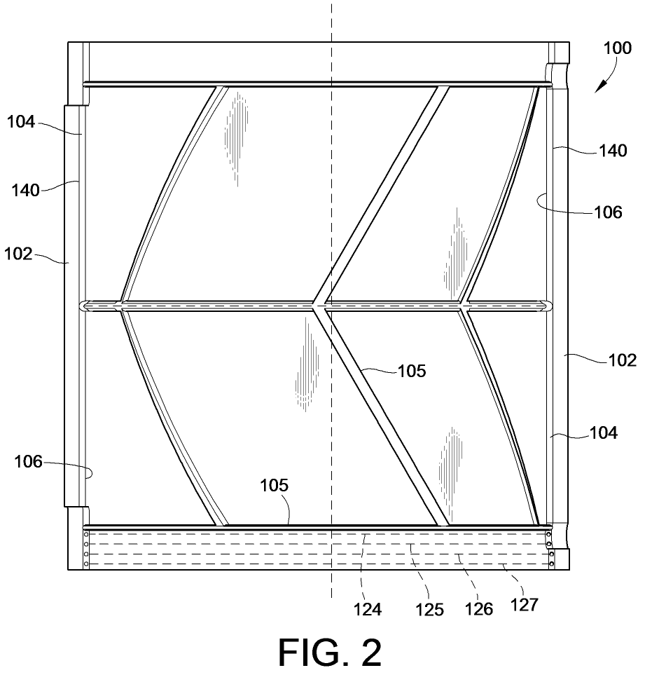

FIGS. 1 and 2 illustrate a first bearing device (as used herein, bushing and bearing can be used interchangeably) according to the teachings of the present invention in the form of a saddle bushing 100. The saddle bushing 100 includes a support 102 supporting a wearable portion in the form of bushing liner 104. As the illustrated bearing is a saddle bushing, the support 102 is in the form of an arcuate U-shaped or trough-shaped shell that is preferably formed from a rigid metal. The bushing liner 104 is preferably formed from polytetrafluoroethylene or other fluoropolymer. However, other materials may be used for the support shell and the bushing liner.

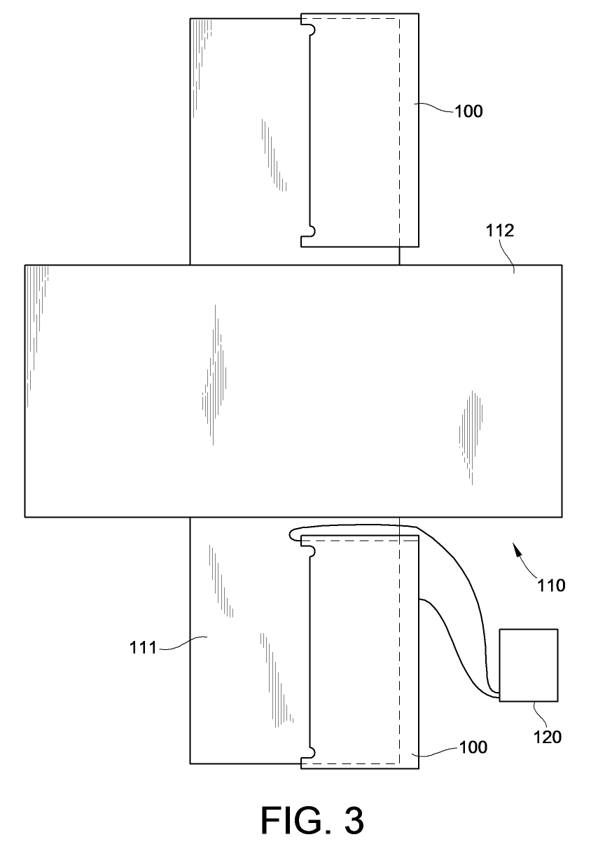

With reference to FIG. 3, the saddle bushing 100 is used to support a rotating body 110 which typically includes a journal 111 or shaft of a rotating load. One particular implementation is the use of the saddle bushing 100 for supporting a journal coupled to a paper drying drum 112 for drying paper in a paper mill. Typically, a film of oil is present between the bushing liner 104 and the supported shaft of the rotating drying drum. The film of oil provides hydrodynamic lifting to help support the shaft or journal to reduce the rate of wear on the bushing liner 104.

The bearing surface 106 of the bushing liner 104 will include oil distribution grooves 105 (see for example FIG. 2) for permitting oil to be distributed between the bushing liner 104 and the shaft or journal.

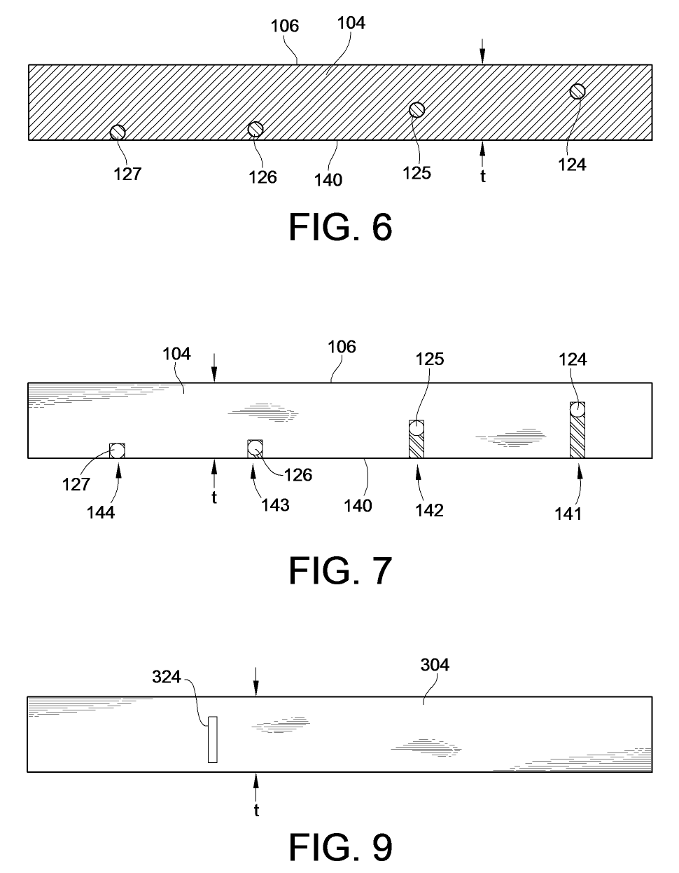

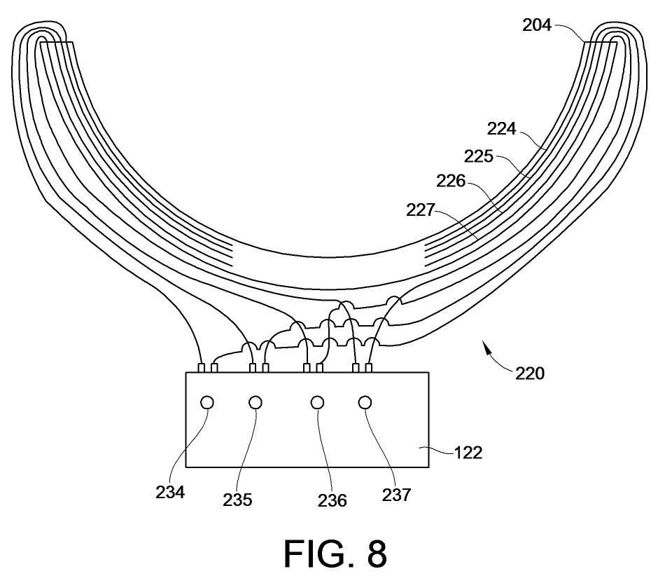

Over time, as the shaft rotates within the saddle bushing 100, the bushing liner 104 will wear reducing its thickness t (see also FIGS. 6-9), including a reduction in the depth of the grooves 105. At a given percentage of wear, the bushing liner 104 is sufficiently worn that the bushing liner 104 is spent and needs to be replaced to prevent the shaft or journal from riding on or contacting the support 102 and to prevent the grooves 105 from being worn away which would prevent the proper amount of oil to pass between the bearing 100 and the shaft.

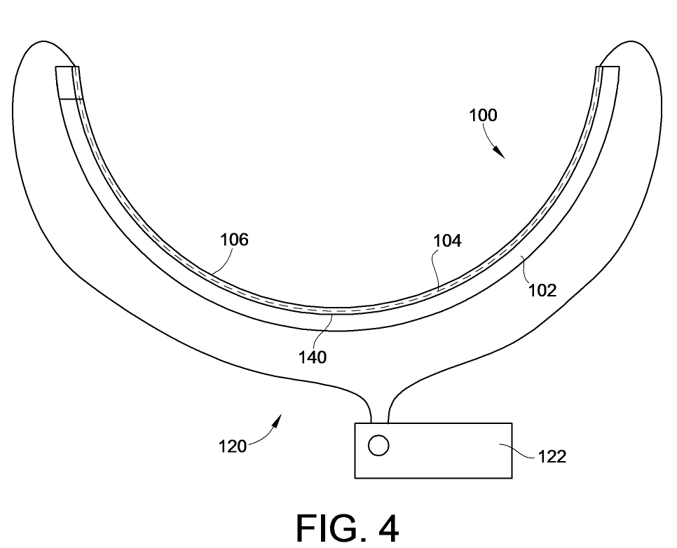

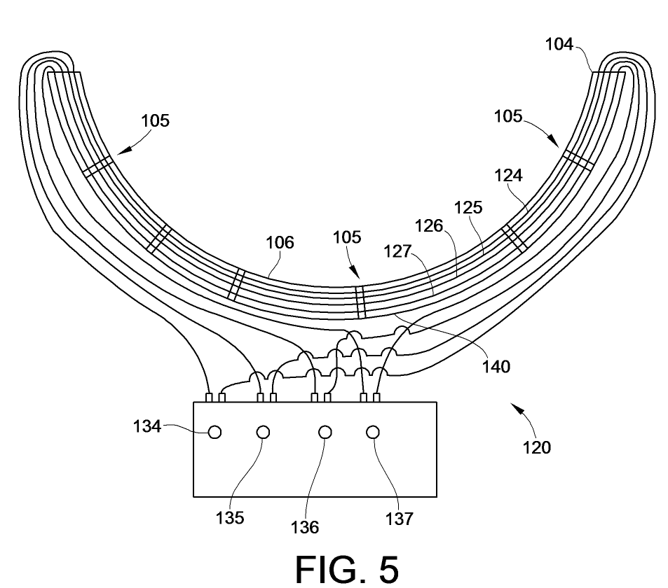

The present saddle bushing 100 includes a wear detection system 120 (illustrated in simplified form in FIGS. 4 and 5) for determining the amount of the bushing liner 104 that has been worn away. The system allows for measurable and predictable bearing life, rather than relying on bearing failure or symptoms of bearing failure for determining the need to replace the bushing 100. The system 120 permits for predictably scheduling downtime for maintenance activities prior to failure of the bushing 100.

The wear detection system 120 of the illustrated embodiment is an electronic system that includes a plurality of sensors imbedded or otherwise mounted into the bushing liner 104 of the saddle bearing 100 connected to an indicator module 122. The sensors of the illustrated embodiment are in the form of wires 124-127 (shown schematically in FIGS. 5 and 6). The wires 124-127 are positioned at various predetermined depths relative to the bearing surface 106 to sense the bushing's remaining useful life.

With primary reference to FIG. 5, the indicator module 122 senses changes in the wires 124-127 to determine the status of the bushing liner 104. In a first embodiment, each of wires 124-127, in an undisturbed state, completes an independent electrical circuit which is monitored by indicator module 122. In the undisturbed state, each wire represents that more useful life is available than the amount of useful life for which the wire represents, as will be more fully explained below.

The indicator module 122 can continuously pass an electrical current through wires 124-127. Alternatively, the indicator module 122 may pulse the sensors so as to reduce the energy consumption of the system 120.

Once the bushing liner 104 has worn sufficiently along its thickness t that wire 124 is worn through, i.e. switching the sensor wire 124, the wire enters a disturbed state and the circuit that includes the wire is broken such that electricity is prevented from passing through the circuit. The indicator module 122 can determine that the circuit is broken and then activate a warning signal, such as indicator light 134. At this point, in the illustrated example, the user is aware that at least twenty-five percent of the useful life of the bushing liner 104 has been spent and between seventy-five percent and fifty percent of the useful life of the bushing liner 104 remains. At this point, none of the other wires 125-127 have become disturbed indicating that at least as much useful life for which they represent still remains.

The same process occurs for the subsequent sensors, i.e. wires 125-127 having indicator lights 135-137, respectively. Thus, once wire 125 is worn through, a reduced level of remaining life is indicated, such as approximately between fifty percent and twenty-five percent of the remaining useful life. Once wire 126 is worn through, the user is informed that seventy-five percent of the useful life has been used and between about twenty-five percent and zero useful life remains. Finally, once wire 127 is worn through, the user is informed that the saddle bushing 100 needs to be replaced as the useful life of the bushing liner 104 has run. Typically, wire 127 will be set so as to a position such that the bearing does not reach absolute failure at the time it is worn through, but that the user needs to address the issue immediately.

The breaking of the circuits that includes wire 124-127 can be sensed using standard sensing technology such as by measuring a change in current flow or a change in potential difference across the circuit or wires 124-127.

In a preferred embodiment, such as illustrated in FIG. 6, the sensor wires 124-127 are directly molded into the bushing liner 104 as the bushing liner 104 is formed. Then, the bushing liner 104 is subsequently secured to support 102.

In an alternative embodiment illustrated in FIG. 7, the sensor wires 124-127 may be subsequently added to the bushing liner 104. As such, the bushing liner 104 may first be formed. Then, grooves 141-144, having different depths corresponding to different percentages of wear, are formed, preferably but not necessarily, in a back side 140 (i.e. a side that is mounted against support 102 and is opposite bearing surface 106). Finally, the wires 124-127 are inserted into the grooves 141-144. The grooves 141-144 may then be filled with a filler, such as an adhesive or a plug of the material forming bushing liner 104 to maintain the wires 124-127 at the desired depth of the grooves.

In some embodiments, the sensor wires 124-127 may include an insulator in the event that bushing liner 104 is formed of a conductive material.

In another alternative embodiment, a wear detection system 220 may be configured as a “normally open” system where the circuits are normally broken and then once the shaft wears through a busing liner 204 sufficiently to complete the circuit by connecting wires 224-227. In such an embodiment, current only flows through the circuit once the circuit is completed. Thus, indicator module 122 can sense when a given circuit at a predetermined depth is completed and thus activate a corresponding warning signal 234-237.

In yet a further embodiment illustrated in FIG. 9, the sensor is in the form of a continuous sheet 324 extending along the thickness t of the bushing liner 304. The sheet conducts electricity much like the wires 124-127. However, the sheet 324 is configured such that it need not be worn completely through to trigger a warning, i.e. switch the sensor. Instead, the sheet 324 is configured such that as the sheet is continuously worn along the thickness t, the electrical properties of the sheet 324 alter. For example, as the sheet is continuously worn, the resistance of the sheet 324 may increase, due to a reduction in cross-sectional area. This change in electrical property can then be sensed by the indicator module 122. In such an arrangement, the configuration permits continuous monitoring or estimation of the remaining useful life of the bushing liner 304 as there are not gaps of non-sensing, such as with the wire arrangements discussed previously.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A bearing for supporting a rotating shaft comprising:
a wearable portion that decreases in thickness as the wearable portion progressively wears due to increased aggregate use of the shaft, the wearable portion including a shaft support surface; and
at least one sensor positioned within the wearable portion at a predetermined position along the thickness of the wearable portion and offset from the shaft support surface in the direction in which the wearable portion wears.

2. The saddle bushing of claim 1, including a plurality of sensors positioned within the wearable portion at differing predetermined positions along the thickness of the wearable portion, different sensors sensing different levels of wear along the thickness of the wearable portion.

3. The bearing of claim 2, wherein the plurality of sensors are embedded in the wearable portion.

4. The saddle bushing of claim 2, wherein plurality of sensors are located in a corresponding groove formed in the wearable portion.

5. The saddle bushing of claim 2, wherein the sensors include continuous wires extending through the wearable portion, wherein when the wearable portion is worn through different depths along the thickness, different ones of the wires become broken preventing a current from flowing through the broken wires to identify a predetermined minimum degree of wear

6. The saddle bushing of claim 5, wherein the wearable portion is a non-conductive material and the wires are un-insulated.

7. The saddle bushing of claim 5, wherein wires are insulated from direct contact with the wearable portion.

8. The bearing of claim 5, wherein the wearable portion is mounted to a rigid support member.

9. The bearing of claim 8, wherein the support member and wearable portion form a saddle bearing that has a u-shaped configuration.

10. The bearing of claim 9, further including an indicator module communicating with the at least one sensor, the indicator module communicating the wear status of the wearable portion to a user.

11. The bearing of claim 1, wherein the sensor includes a continuous sheet of electricity conducting material extending a long the thickness of the wearable portion that changes electrical properties upon reduction in a cross-sectional area of the sheet of electricity conducting material.

12. A method of monitoring wear of a wearable portion of a bearing comprising the steps of:
sensing an electrical property of a first sensor mounted in a wearable portion of the bearing that decreases in thickness as the wearable portion progressively wears, the wearable portion including a support surface, the first sensor being mounted a first predetermined distance from the support surface; and;
sensing a change in the electrical property of the first sensor; and
determining a first degree of wear of the wearable portion upon the sensed change in the electrical property of the first sensor.

13. The method of claim 12, wherein the step of sensing a change in the electrical property of the first sensor includes sensing that an electrical circuit established by the first sensor is completed.

14. The method of claim 12, wherein the step of sensing a change in the electrical property of the first sensor includes sensing that an electrical circuit established by the first sensor is broken.

15. The method of claim 14, further including the steps of:
sensing an electrical property of a second sensor mounted in the wearable portion of the bearing a second predetermined distance from the support surface, the second predetermined distance being further from the support surface than the first predetermined distance; and;
sensing a change in the electrical property of the second sensor; and
determining a second degree of wear of the wearable portion upon the sensed change in the electrical property of the second sensor.

16. The method of claim 15, wherein the first degree of wear identifies an acceptable amount of wear and the second degree of wear identifies a replacement required degree of wear.

17. The method of claim 16, wherein the second degree of wear is established at a non-complete failure predetermined distance from the support surface.

18. A rotatable drying drum for drying moist articles comprising:
a drum in which moist articles maybe be dried;
a journal operably coupled to the drum;
a bearing supporting the journal for rotation on a wearable portion, the wearable portion configured to wear a predetermined amount before needing replacement;
a sensor disposed within the wearable portion a predetermined distance from a bearing surface of the wearable portion, wherein interaction of the journal and the sensor after a predetermined amount of wear in the wearable portion allows determination that said amount of wear of the wearable portion has occurred.

19. The rotatable drying drum of claim 18, wherein the sensor is in the form of a wire spaced apart from the bearing surface along a thickness of the wearable surface.

20. The rotatable drying drum of claim 19, further including:
a plurality of sensors in the form of a plurality of wires disposed within the wearable portion, different ones of the sensors being spaced at different positions relative to the bearing surface; and
an indicator module operably coupled to the plurality of sensors, the indicator module including an indicator device for each of the sensors indicating switching of each of the sensors.

21. The rotatable drying drum of claim 20, wherein the bearing is a saddle bearing further including a support portion, the support portion supporting the wearable portion, the wearable portion being positioned between the support portion and the wearable portion, the wearable portion further including lubrication channels formed in the bearing surface.

22. The rotatable drying drum of claim 21, wherein the wire is imbedded in the wearable portion such that the wearable portion is a continuous piece except for the inclusion of the wire.

23. The rotatable drying drum of claim 18, wherein the sensor includes a continuous sheet of electricity conducting material that changes electrical properties upon reduction in a cross-sectional area of the sheet of electricity conducting material.
